(19) United States
(12) Patent Application Publication
(10) Pub. No.: US 2009/0200116 A1
(43) Pub. Date: Aug. 13, 2009

(54) MULTI-FUNCTION JOYSTICK FOR FORKLIFT CONTROL

(76) Inventors: Michael M. Wiggins, Thousand Oaks, CA (US); Bruce W. Farber, Oxnard, CA (US); Liming Yue, Camarillo, CA (US)

Correspondence Address: KELLY LOWRY & KELLEY, LLP, 6320 CANOGA AVENUE, SUITE 1650, WOODLAND HILLS, CA, 91367, US

(21) Appl. No.: 12/030,016

(22) Filed: Feb. 12, 2008

(51) Int. Cl. B66F 9/20

(52) U.S. Cl. 187/224

(57) ABSTRACT

A multi-function joystick system controls forklift mast, tilt and fork functions. The system includes a single joystick pivotable about two axes and having first, second and third buttons and a trigger. Combinations of pivoting the joystick alone or in combination with pressing buttons and triggers performs eight forklift functions including negative lift/lower, free lift/lower, maximum lift/lower, tilt forward/backward, left fork left/right, right fork left/right, both forks left/right, and fork open/close.

### FIELD OF THE INVENTION

This invention relates to a control system for operating a forklift. More specifically, the present invention relates to a multi-function joystick system for controlling forklift mast, tilt and fork functions.

### BACKGROUND OF THE INVENTION

Forklifts are used in a wide variety of industrial settings and with various functions. Such functions include lift/lower of the forks, tilt the mast backward/forward, and adjusting the lateral position of the forks.

A typical prior art forklift includes two, three or more levers, buttons and/or switches to control one or more of these functions. Such a multiplicity of levers, buttons and/or switches is complicated and often times confusing. A forklift operator must make higher level decisions when manipulating such a multiplicity of levers, buttons and/or switches many times requiring the use of two hands to perform the most basic functions.

Accordingly, there is a need for an improved system for controlling multiple functions on a forklift truck. There is a further need for such system to be easily understood and operated. The present invention fulfills these needs and provides other related advantages.

### SUMMARY OF THE INVENTION

A multi-function joystick system for controlling forklift mast, tilt and fork functions comprises a joystick pivotable about two axes having first, second and third buttons and a trigger, a mast controller, a tilt controller, and a fork controller. The mast controller is responsive to pivotal movement of the joystick about the first axis. The tilt controller is responsive to pivotal movement of the joystick about the second axis. The fork controller is responsive to pivotal movement of the joystick about the first axis in combination with the first button and trigger. The fork controller is also responsive to pivotal movement of the joystick about the second axis in selective combination with the first, second or third buttons.

The system also includes a left actuator associated with a left fork and a right actuator associated with a right fork. The left and right actuators are responsive to the fork controller for shifting the left and right forks laterally. A left sensor is associated with the left actuator for determining a lateral position of the left fork. A right sensor is associated with the right actuator for determining a lateral position of the right fork. The left and right forks are jointly shifted by pressing the first button and pivoting the joystick along the second axis. The left fork is independently shifted by pressing the second button and pivoting the joystick along the second axis. The right fork is independently shifted by pressing the third button and pivoting the joystick along the second axis. The distance between the left and right forks is shifted by pressing the first button in combination with the trigger and pivoting the joystick along the first axis.

The system also includes a mast actuator responsive to the mast controller for raising and lowering a multi-stage mast. A mast sensor is associated with the mast actuator for determining a height of an inner mast section. First and second multistate switches are associated with the inner mast section. Such switches change states based upon the height of the inner mast section.

The first switch is in a closed state and the second switch is in an open state when the multi-stage mast is in a negative lift stage. The first and second switches are both in an open state when the multi-stage mast is in a free lift stage. The first switch is in an open state and the second switch is in a closed state when the multi-stage mast is in a maximum lift stage. The mast is raised or lowered by pivoting the joystick along the first axis.

The system also includes a tilt actuator responsive to the tilt controller for tilting a mast forward and backward. A tilt sensor is associated with the tilt actuator for determining a tilt angle of the mast. The mast is tilted forward or backward by pivoting the joystick along the second axis.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a side view of the multi-function joystick of the present invention;

FIG. 2 is a rear view of the multi-function joystick of the present invention;

FIG. 3 is a side view of the multi-function joystick of the present invention illustrating pivotal movement about a first axis;

FIG. 4 is a rear view of the multi-function joystick of the present invention illustrating pivotal movement about the second axis;

FIG. 5 is an illustration of an operator console including the multi-function joystick of the present invention;

FIG. 6 is a flow chart illustrating the relationship of components of the multi-function joystick system of the present invention.

FIG. 7 is a flow chart illustrating control logic of the system of the present invention; and

FIG. 8 is a flow chart illustrating further control logic of the joystick system of the present invention.

### DETAILED DESCRIPTION OF THE PREFERRED EMBODIMENTS

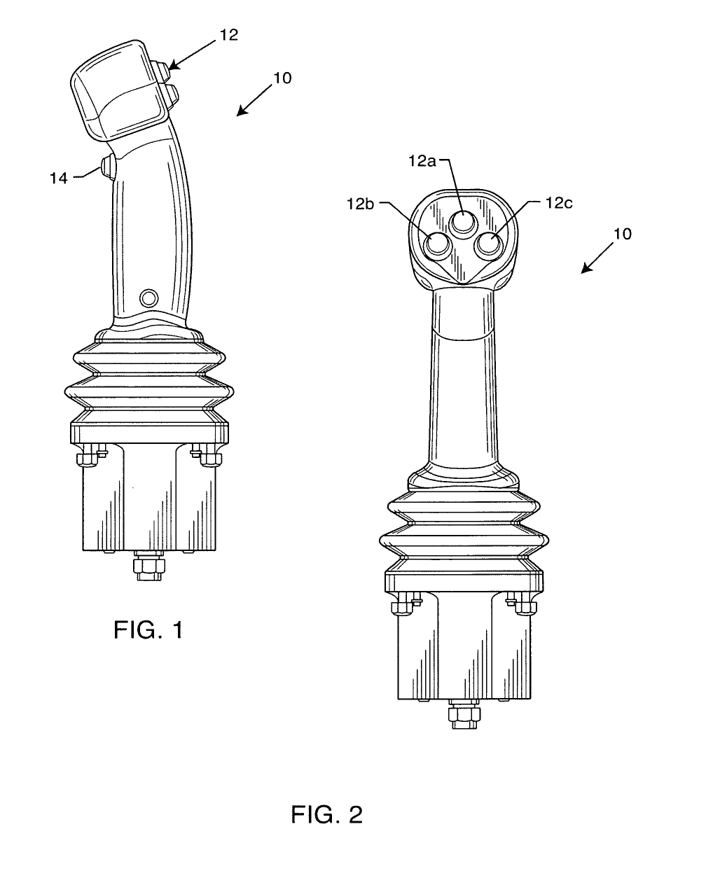

As shown in the drawings for purposes of illustration, the present disclosure relates to a multi-function joystick system for controlling forklift mast, tilt and fork functions. As illustrated in FIGS. 1-5 the present invention resides in a single joystick 10 to handle all forklift mast, tilt and fork functions, primarily for a boat handling forklift. There are eight bidirectional functions controlled by the joystick 10 including: free lift/lower; negative lift/lower; maximum lift/lower; tilt forward/backward; left fork left/right; right fork left/right; shift forks left/right; and forks open/close.

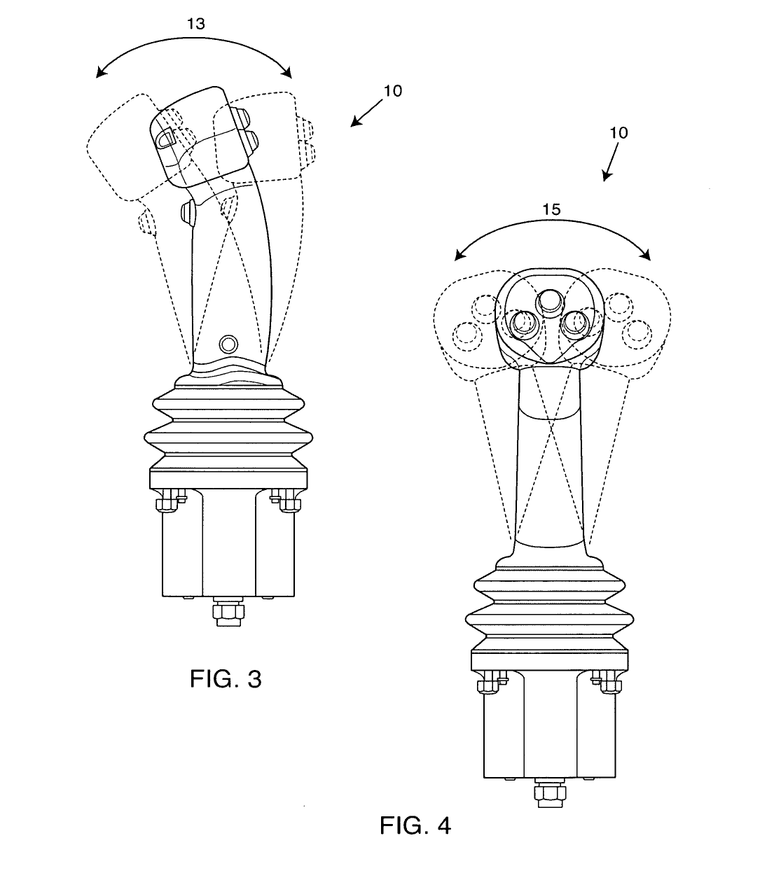

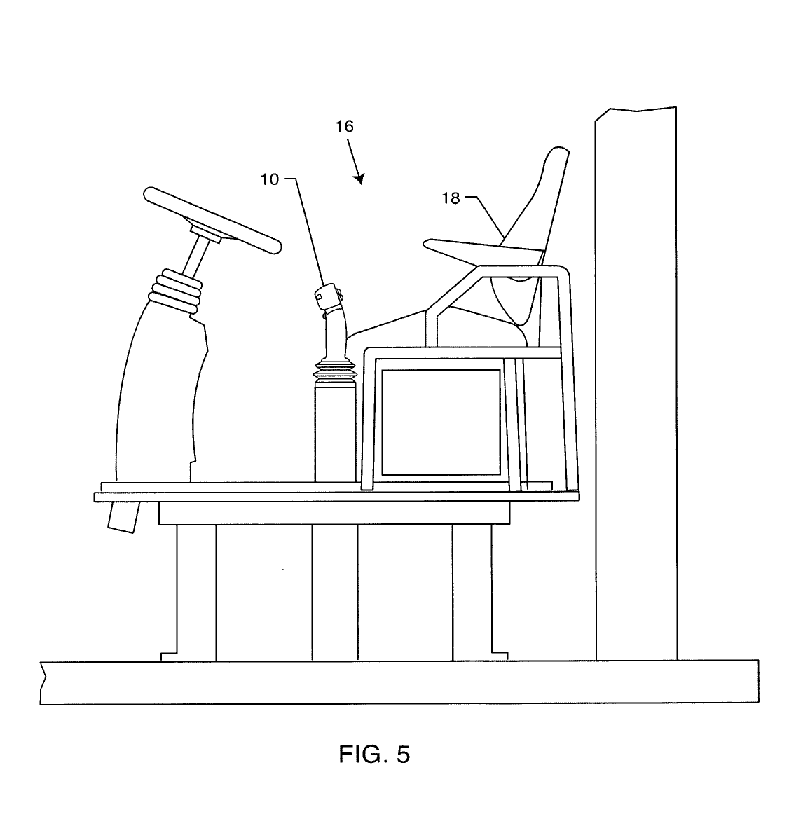

Specific control in the form of a combination of actions and/or settings is needed to perform these functions. The joystick 10 includes three buttons 12a, 12b, 12c and a trigger 14. The buttons 12 and trigger 14 work in combination with pivotal movement of the joystick 10 about two axes as illustrated in FIGS. 3 and 4. The joystick is pivotable about a first axis 13, i.e., forward and backward with center return as illustrated in FIG. 3, and a second axis 15, i.e., side-to-side with center return as illustrated in FIG. 4.

As depicted in FIG. 5, the joystick 10 should be positioned in the operator console 16 of a forklift truck proximate the controller's seat 18. Preferably, the joystick 10 is positioned between the operator's knees but may be positioned on either side of the seat 18 so as to be readily accessible to an operator.

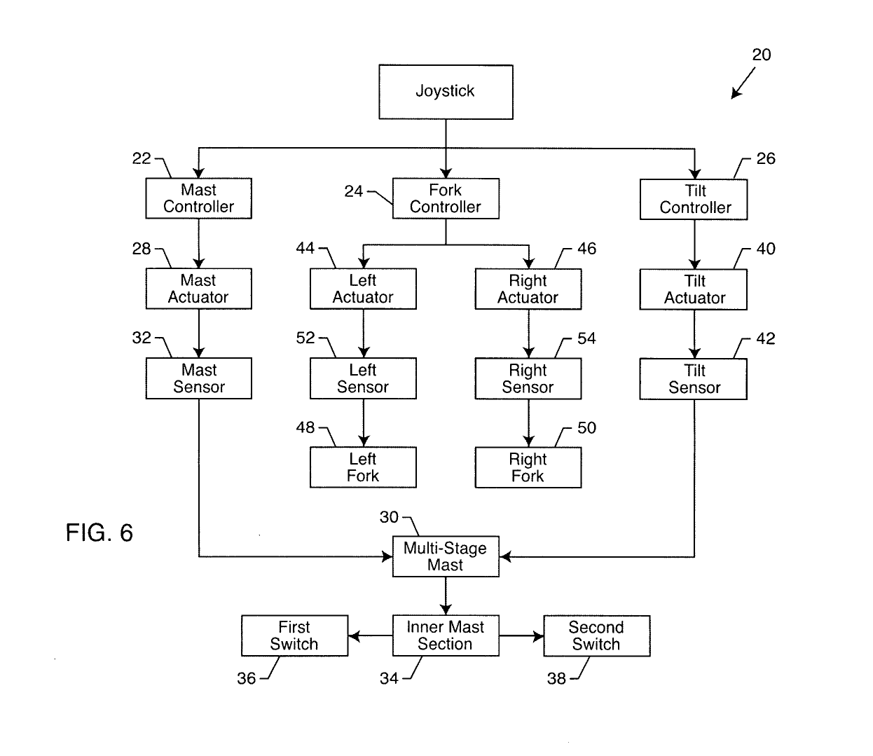

FIG. 6 is a block diagram illustrating the various components of the multi-function joystick system 20. The system includes the joystick 10 along with a mast controller 22, a fork controller 24 and a tilt controller 26. The mast controller 22 is responsive to pivotal movement of the joystick 10 about the first axis 13. The system 20 includes a mast actuator 28 responsive to the mast controller 22. The mast actuator 28 is responsible for raising and lowering a multi-stage mast 30. A mast sensor 32 is associated with the mast actuator 28 for determining the current height of an inner mast section 34. The height of the inner mast section 34 will determine whether the multi-stage mast 30 is in a negative lift stage, a free lift stage, or a maximum lift stage. In the case of a multi-stage mast 30 having only two hydraulic cylinders responsible for raising and lower the mast, as described in U.S. patent application Ser. No. 11/832,522 filed on Aug. 1, 2007, the system 20 includes first and second multi-state switches 36, 38 associated with the inner mast section 34.

The switches 36, 38 will change states, i.e., open or closed, based upon the current lift stage as determined by the mast sensor 32. When the mast 30 is in the negative lift stage, i.e., between ground level and its fully lowered height, the first switch 36 is in a closed state and the second switch 38 is in an open state for both lift and lower functions. When the mast 30 is in the free lift stage, i.e., between ground level and the top of free lift, both the first switch 36 and the second switch 38 are in an open state. When the mast 30 is in the maximum lift stage, i.e., between the top of free lift and the maximum lift height, the first switch 36 is in an open state and the second switch 38 is in a closed state. The above-described states of the first and second multi-state switches 36, 38 are examples of preferred conditions. One will realize that different combinations of states can be programmed, i.e., opposite conditions, to achieve similar results. However, the first and second switches 36, 38 should have opposite states for both the negative lift stage and the maximum lift stage and similar states for the free lift stage.

The system 20 also includes a tilt actuator 40 responsive to the tilt controller 26. The tilt actuator 40 is responsible for tilting the mast 30 forward and backward. A tilt sensor 42 associated with the tilt actuator 40 measures the current angle of tilt of the mast 30.

The system 20 also includes left and right fork actuators 44, 46. The left actuator 44 is associated with a left fork 48 and the right actuator 46 is associated with a right fork 50. The left and right actuators 44, 46 are responsive to the fork controller 24. The left and right actuators 44, 46 shift the left and right forks 48, 50 in lateral directions. A left sensor 52 is associated with the left actuator 44 for determining a lateral position of the left fork 48. Similarly, a right sensor 54 is associated with the right actuator 46 for determining the lateral position of the right fork 50.

The forks 48, 50 may be laterally shifted as follows:
The left fork 48 may be independently shifted left or right by the left actuator 44;
The right fork 50 may be independently shifted left or right by the right actuator 46;
The left and right forks 48, 50 may be jointly shifted left or right by the joint action of the left actuator 44 and the right actuator 46;
The distance between the left fork 48 and right fork 50 may be increased or decreased by the combined action of the left actuator 44 and the right actuator 46.

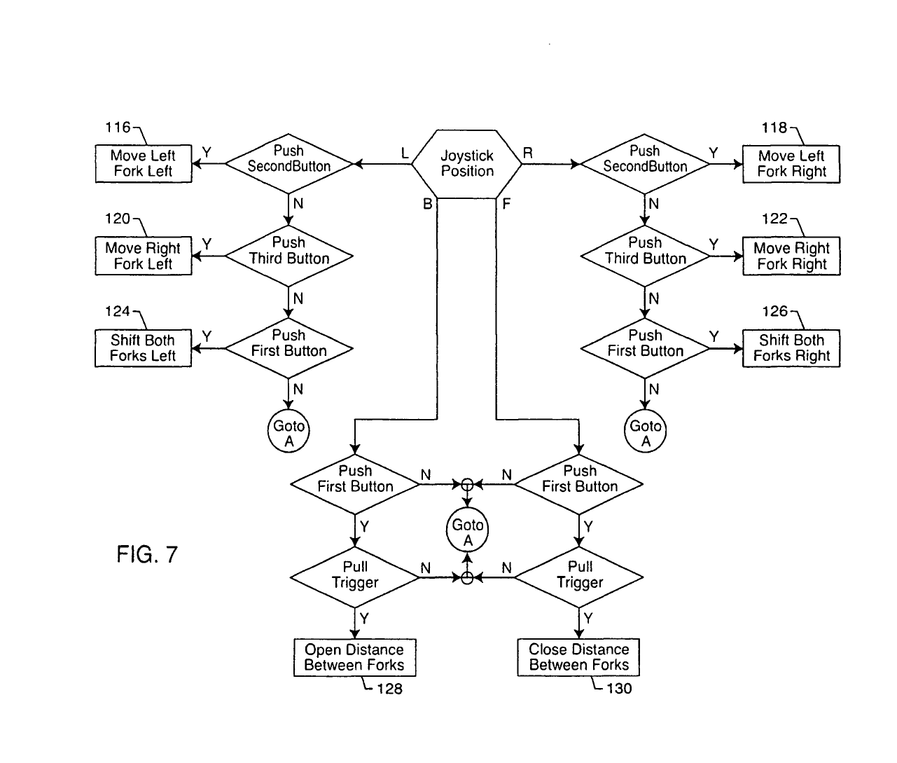

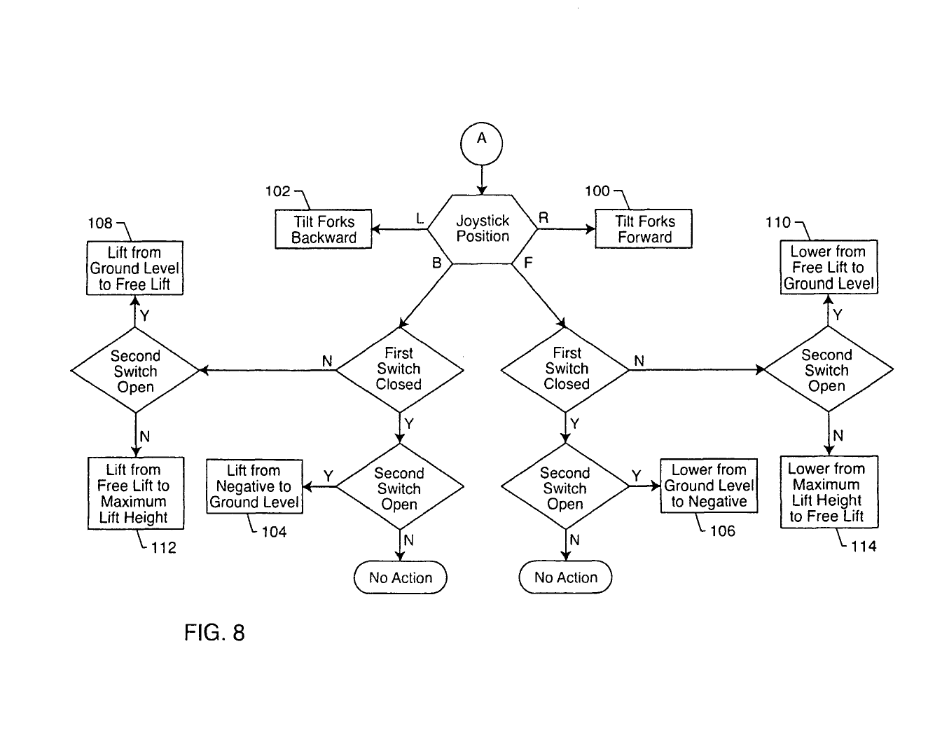

As illustrated in FIGS. 7 and 8, the control logic of the system 20 is fairly straightforward. The mast 30 is tilted forward 100 or backward 102 by pivoting the joystick 10 along the second axis 15, i.e., right or left. The mast 30 is raised or lowered by pivoting the joystick 10 along the first axis 13, i.e., forward or backward. One of six lift/lower functions for the mast 30 is activated depending upon the state of the first and second switches 36, 38. If the first switch 36 is closed and the second switch is open then pivoting the joystick 10 backward will lift the mast 30 through negative height to ground level 104, and pivoting the joystick 10 forward will lower the mast 30 from ground level to a negative height 106. If the first switch 36 is open and the second switch 38 is open then pivoting the joystick 10 backward will lift the mast 30 from ground level to the top of free lift 108, and pivoting the joystick 10 forward will lower the mast 30 from the top of free lift to ground level 110. If the first switch 36 is open and the second switch 38 is closed then pivoting the joystick 10 backward will lift the mast 30 from the top of free lift to the maximum lift height 112, and pivoting the joystick 10 forward will lower the mast 30 from the maximum lift height to the top of free lift 114.

In the preferred embodiment, the system 20 is not programmed for and no action will result from a condition in which both the first and second switches 36, 38 are closed. One will realize that this depends upon how the system 20 is programmed as discussed above. If the system 20 were programmed oppositely such that opposite states apply then having both the first and second switches 36, 38 closed would result in lift from ground level to the top of free lift 108 with forward movement of the joystick 10 and lower from the top of free lift to ground level 110 with backward movement of the joystick 10, and having both the first and second switches 36, 38 open would result in no action.

The left and right forks 48, 50 are shifted laterally by pivoting the joystick 10 in combination with buttons 12 and/or the trigger 14. The left fork 48 is shifted left 116 or right 118 by pivoting the joystick 10 along the second axis 15, i.e., left or right, in combination with pushing the second button 12b, i.e., the left button. Similarly, the right fork 50 is shifted left 120 or right 122 by pivoting the joystick 10 along the second axis 15, i.e., left or right, in combination with pushing the third button 12c, i.e., the right button. To make the system 20 more intuitive, the second button 12b is positioned near the left side of the joystick 10 and the third button 12c is positioned near the right side of the joystick 10. However, placement of the second button 12b and third button 12c is not critical to the system 20.

The left and right forks 48, 50 are shifted laterally together by pivoting the joystick 10 along the second axis 15, i.e., left or right, and pushing the first button 12a, i.e., the center button. Pivoting the joystick 10 left and pressing the center button 12c will shift both forks 48, 50 left 124. Pivoting the joystick 10 right and pushing the center button 12c will shift both forks 48, 50 right 126.

The distance between the forks is opened 128 or closed 130 through a combination of pivoting the joystick 10 along the first axis, pushing the center button 12c and pulling the trigger 14. To open the distance between the forks 128, one pivots the joystick 10 backward while simultaneously pushing the center button 12c and pulling the trigger 14. To close the distance between the forks 130, one pivots the joystick 10 forward while simultaneously pushing the center button 12c and pulling the trigger 14. By programming the system 20 in this manner, specific control in the form of a combination of actions is needed to prevent accidentally opening or closing the distance between the forks which could result in dropping or damaging the load being carried.

Although several embodiments have been described in detail for purposes of illustration, various modifications may be made without departing from the scope and spirit of the invention. Accordingly, the invention is not to be limited, except as by the appended claims.

What is claimed is:

1. A multi-function joystick system for controlling forklift mast, tilt and fork functions, comprising:
a joystick pivotable about two-axes and having first, second and third buttons and a trigger;
a mast controller responsive to pivotal movement of the joystick about the first axis;
a tilt controller responsive to pivotal movement of the joystick about the second axis; and
a fork controller responsive to pivotal movement of the joystick about the first axis in combination with the first button and the trigger, and pivotal movement of the joystick about the second axis in selective combination with the first, second or third button.

2. The multi-function joystick system of claim 1, further comprising a left actuator associated with a left fork, and a right actuator associated with a right fork, said left and right actuators responsive to the fork controller for laterally shifting said left and right forks.

3. The multi-function joystick system of claim 2, further comprising a left sensor associated with the left actuator for determining a lateral position of the left fork, and a right sensor associated with the right actuator for determining a lateral position of the right fork.

4. The multi-function joystick system of claim 2, wherein the left and right forks are jointly shifted by pressing the first button and pivoting the joystick along the second axis.

5. The multi-function joystick system of claim 2, wherein the left fork is independently shifted by pressing the second button and pivoting the joystick along the second axis.

6. The multi-function joystick system of claim 2, wherein the right fork is independently shifted by pressing the third button and pivoting the joystick along the second axis.

7. The multi-function joystick system of claim 2, wherein the distance between the left and right forks is shifted by pressing the first button in combination with the trigger and pivoting the joystick along the first axis.

8. The multi-function joystick system of claim 1, further comprising a mast actuator responsive to the mast controller for raising and lowering a multi-stage mast.

9. The multi-function joystick system of claim 8, further comprising a mast sensor associated with the mast actuator for determining a height of an inner mast section.

10. The multi-function joystick system of claim 9, further comprising first and second multi-state switches associated with the inner mast section.

11. The multi-function joystick system of claim 10, wherein the switches change states based upon the height of the inner mast section.

12. The multi-function joystick system of claim 10, wherein the first switch is in a closed state and the second switch is in an open state when the multi-stage mast is in a negative lift stage.

13. The multi-function joystick system of claim 10, wherein the first switch is in an open state and the second switch is in an open state when the multi-stage mast is in a free lift stage.

14. The multi-function joystick system of claim 10, wherein the first switch is in an open state and the second switch is in a closed state when the multi-stage mast is in a maximum lift stage.

15. The multi-function joystick system of claim 8, wherein the mast is raised or lowered by pivoting the joystick along the first axis.

16. The multi-function joystick system of claim 1, further comprising a tilt actuator responsive to the tilt controller for tilting a mast forward and backward.

17. The multi-function joystick system of claim 16, further comprising a tilt sensor associated with the tilt actuator for determining a tilt angle of the mast.

18. The multi-function joystick system of claim 16, wherein the mast is tilted forward or backward by pivoting the joystick along the second axis.

19. A multi-function joystick system for controlling forklift mast, tilt and fork functions, comprising:
a joystick pivotable about two-axes and having first, second and third buttons and a trigger;
a mast controller responsive to pivotal movement of the joystick about the first axis;
a tilt controller responsive to pivotal movement of the joystick about the second axis; and
a fork controller responsive to pivotal movement of the joystick about the first axis in combination with the first button and the trigger, and pivotal movement of the joystick about the second axis in selective combination with the first, second or third button, wherein a left fork and a right fork are jointly shifted by pressing the first button and pivoting the joystick along the second axis, wherein the left fork is independently shifted by pressing the second button and pivoting the joystick along the second axis, wherein the right fork is independently shifted by pressing the third button and pivoting the joystick along the second axis, and wherein the distance between the left and right forks is shifted by pressing the first button in combination with the trigger and pivoting the joystick along the first axis.

20. The multi-function joystick system of claim 19, further comprising a left actuator associated with the left fork, and a right actuator associated with the right fork, said left and right actuators responsive to the fork controller for laterally shifting said left and right forks, a left sensor associated with the left actuator for determining a lateral position of the left fork, and a right sensor associated with the right actuator for determining a lateral position of the right fork.

21. The multi-function joystick system of claim 19, further comprising a mast actuator responsive to the mast controller for raising and lowering a multi-stage mast, a mast sensor associated with the mast actuator for determining a height of an inner mast section, and first and second multi-state switches associated with the inner mast section.

22. The multi-function joystick system of claim 21, wherein the switches change states based upon the height of the inner mast section.

23. The multi-function joystick system of claim 22, wherein the first switch is in a closed state and the second switch is in an open state when the multi-stage mast is in a negative lift stage, wherein the first switch is in an open state and the second switch is in an open state when the multi-stage mast is in a free lift stage, and wherein the first switch is in an open state and the second switch is in a closed state when the multi-stage mast is in a maximum lift stage.

24. The multi-function joystick system of claim 19, further comprising a tilt actuator responsive to the tilt controller for tilting a mast forward and backward, and a tilt sensor associated with the tilt actuator for determining a tilt angle of the mast, wherein the mast is tilted forward or backward by pivoting the joystick along the second axis.

25. A multi-function joystick system for controlling forklift mast, tilt and fork functions, comprising:
a joystick pivotable about two-axes and having first, second and third buttons and a trigger;
a mast controller responsive to pivotal movement of the joystick about the first axis;
a mast actuator responsive to the mast controller for raising and lowering a multi-stage mast, a mast sensor associated with the mast actuator for determining a height of an inner mast section, and first and second multi-state switches associated with the inner mast section;
a tilt controller responsive to pivotal movement of the joystick about the second axis;
a fork controller responsive to pivotal movement of the joystick about the first axis in combination with the first button and the trigger, and pivotal movement of the joystick about the second axis in selective combination with the first, second or third button;
a left actuator associated with a left fork, and a left sensor associated with the left actuator for determining a lateral position of the left fork;
a right actuator associated with a right fork, and a right sensor associated with the right actuator for determining a lateral position of the right fork; and
said left and right actuators responsive to the fork controller for laterally shifting said left and right forks, wherein the left and right forks are jointly shifted by pressing the first button and pivoting the joystick along the second axis, wherein the left fork is independently shifted by pressing the second button and pivoting the joystick along the second axis, wherein the right fork is independently shifted by pressing the third button and pivoting the joystick along the second axis, and wherein the distance between the left and right forks is shifted by pressing the first button in combination with the trigger and pivoting the joystick along the first axis.

26. The multi-function joystick system of claim 25, wherein the switches change states based upon the height of the inner mast section.

27. The multi-function joystick system of claim 26, wherein the first switch is in a closed state and the second switch is in an open state when the multi-stage mast is in a negative lift stage, wherein the first switch is in an open state and the second switch is in an open state when the multi-stage mast is in a free lift stage, and wherein the first switch is in an open state and the second switch is in a closed state when the multi-stage mast is in a maximum lift stage.

28. The multi-function joystick system of claim 25, further comprising a tilt actuator responsive to the tilt controller for tilting a mast forward and backward, and a tilt sensor associated with the tilt actuator for determining a tilt angle of the mast, wherein the mast is tilted forward or backward by pivoting the joystick along the second axis.
